(19) United States
(12) Patent Application Publication
(10) Pub. No.: US 2005/0253510 A1
(43) Pub. Date: Nov. 17, 2005

(54) Light-emitting device and display device

(76) Inventors: Shogo Nasu, Hyogo (JP); Masayuki Ono, Osaka (JP); Toshiyuki Aoyama, Osaka (JP); Masaru Odagiri, Hyogo (JP)

Correspondence Address: MCDERMOTT WILL & EMERY LLP, 600 13TH STREET, N.W., WASHINGTON, DC, 20005-3096, US

(21) Appl. No.: 11/051,993

(22) Filed: Jan. 27, 2005

(30) Foreign Application Priority Data
May 11, 2004 (JP) P2004-140774

(51) Int. Cl. H01J 1/62; H05B 33/22

(52) U.S. Cl. 313/509; 313/506

(57) ABSTRACT

A light-emitting device having first electrodes, a dielectric layer, a phosphor layer, and second electrodes layered sequentially on a substrate, the dielectric layer is made from a dielectric composed of a crystalline material with a perovskite structure where the lattice constant of the c-axis is greater than the lattice constant of the a-axis obtained by x-ray diffraction.

### BACKGROUND OF THE INVENTION

1. Field of Technology

The present invention relates to a light-emitting device that emits light when voltage is applied to an inorganic phosphor, and to a display device using this light-emitting device.

2. Description of Related Art

Light-emitting devices (electroluminescent devices, referred to as “EL devices” below) that use an inorganic phosphor such as zinc sulfide as the luminous element are self-emissive and feature excellent readability, a wide viewing angle, and fast response. Due to these characteristics, EL elements are well-suited for application in television displays, personal computer displays, and other types of display devices. As a result, various proposals have been made to provide practical low cost, high luminance EL devices.

A typical EL device has a first electrode layer, an emitting layer including a dielectric layer and an inorganic phosphor layer, and a second electrode layer built over a base substrate. The emission luminance of this type of EL element increases proportionally to the voltage applied to the phosphor layer. Therefore, if the applied voltage is raised to increase luminance, the dielectric strength characteristics of the dielectric layer are important as described below.

When emitting drive voltage Va is applied between the first electrode and second electrode, the voltage Vp applied to the phosphor layer and the voltage Vi applied to the dielectric layer can be determined from the following equations (1-1) and (1-2),
Vp=((εi*dp)/((εi*dp+εp*di))*Va (1-1)
Vi=((εp*di)/((εp*di+εi*dp))*Va (1-2)
where εi is the dielectric constant of the dielectric layer, εp is the dielectric constant of the phosphor layer, di is the thickness of the dielectric layer, and dp is the thickness of the phosphor layer. (See, for example, page 386 in Dictionary of Flat Panel Displays (Tatsuo Uchida, Heiju Uchiike, eds., Kogyo Chosakai, 25 December 2001).)

As will be known from equations (1-1) and (1-2), the dielectric constant εi of the dielectric layer must be increased and the layer thickness di decreased, and the dielectric strength of the dielectric layer must be voltage Vi or greater, in order to increase the voltage Vp applied to the phosphor layer and increase the output luminance. How to reduce the dielectric layer thickness while simultaneously achieving a high dielectric strength is an important technical problem that must be solved in order to achieve a dielectric layer affording high luminance.

One commonly proposed method is to form the dielectric layer by sputtering or other thin film deposition technique. As taught in Japanese Patent Laid-open Publication No. 2001-196184, however, due to the low-density of the dielectric crystals formed by thin film deposition, the dielectric strength of the dielectric layer is low. As a result, when a high voltage is applied to the phosphor layer, the dielectric layer fails, and the output luminance cannot be increased. To solve this problem, Japanese Patent Laid-open Publication No. 2001-196184 teaches forming the dielectric layer using a thick film deposition method to increase the density of the dielectric layer and thereby increase the insulation breakdown voltage.

More specifically, a dielectric paste of Ba₂AgNbO₁₅ powder dispersed in a binder resin is screen printed to an alumina substrate and then annealed at 1100° C. to form a high density dielectric layer. Asperities (or roughness) of 1 μm or more are formed in the dielectric layer surface by this process. When the phosphor layer is then formed over a dielectric layer with asperities (or roughness) of 1 μm or more, insulation breakdown of the phosphor layer results when the drive voltage is subsequently applied. The surface of the dielectric layer must therefore be polished and smoothed so that all surface asperities (or roughness) are less than 1 μm. High luminance can thus be achieved.

A problem with the conventional EL element taught in Japanese Patent Laid-open Publication No. 2001-196184 is that because the dielectric layer is annealed at 1100° C., a special substrate with high heat resistance must be used, and the cost of materials thus rises.

In addition, a separate process for smoothing the surface of the dielectric layer after annealing is also required. This increases the number of production steps and thus increases production cost.

### SUMMARY OF THE INVENTION

The present invention is directed to solving these problems of the prior art, and an object of this invention is to provide an EL device whereby both reduced cost and increased luminance can be simultaneously achieved. A further object is to provide a display device using this EL device.

An EL device according to the present invention has an emitting layer including a phosphor layer and a dielectric layer, and a pair of electrodes for applying an electric field to the phosphor layer. The dielectric layer is composed of a crystalline material having a perovskite structure in which a lattice constant of a c-axis is greater than a lattice constant of an a-axis. This simultaneously affords high luminance and a low device cost.

A display device according to the present invention is a passive matrix display device having a light-emitting device composed of striped first electrodes, a dielectric layer, a phosphor layer, and striped second electrodes orthogonal to the first electrodes, and a drive circuit for applying a drive voltage between the first and second electrodes and thereby causing the phosphor layer to emit. The dielectric layer of this light-emitting device is made from a dielectric composed of a crystalline material with a perovskite structure where the lattice constant of the c-axis is greater than the lattice constant of the a-axis obtained by x-ray diffraction. This simultaneously affords high luminance and a low device cost.

Thus comprised, an EL device and display device according to the present invention afford high luminance because of the high insulation breakdown voltage of the dielectric layer, and reduced cost because a low cost general purpose glass substrate can be used. Our invention thus affords the high luminance and low unit cost that are well suited to televisions and other displays.

### BRIEF DESCRIPTION OF THE DRAWINGS

Other objects and attainments together with a fuller understanding of the invention will become apparent and appreciated by referring to the following description and claims taken in conjunction with the accompanying drawings, wherein like parts are denoted by like reference numerals.

FIG. 1 is a section view of an EL device according to the present invention;

FIG. 2 schematically shows the crystal structure of a dielectric material used in the present invention;

FIG. 3A is a graph of the relationship between environmental temperature and luminance in this EL device, and FIG. 3B shows the measurement data plotted in the graph in FIG. 3A;

FIG. 4 is an x-ray diffraction diagram in a partial angular range of the dielectric layer;

FIG. 5A is a graph comparing emission luminance and the lattice constant ratio c/a of the dielectric crystals used in the dielectric layer, and FIG. 5B shows the measurement data plotted in the graph in FIG. 5A;

FIG. 6 is a graph of the relationship between luminance and the x-ray diffraction intensity ratio of the (002) and (200) faces of the dielectric crystals used in the dielectric layer;

FIG. 7A is a graph relating diffraction intensity to the indexed surfaces in the x-ray diffraction diagram of the dielectric layer, and FIG. 7B shows the measurement data plotted in FIG. 7A;

FIG. 8A is a graph of the relationship between luminance and the thickness of the dielectric layer, and FIG. 8B shows the measurement data plotted in FIG. 8A;

FIG. 9A is a graph of the relationship between luminance and the surface roughness of the dielectric layer according to the present invention, and FIG. 9B shows the measurement data plotted in FIG. 9A;

FIG. 10 is a section view of an EL device according to a second embodiment of the present invention;

FIG. 11 is a section view of an EL device according to a third embodiment of the present invention;

FIG. 12 schematically shows the main parts of a display device according to a fourth embodiment of the present invention;

FIG. 13 is a section view of a display device according to a variation of the fourth embodiment of the invention;

FIG. 14 is a section view of a display device according to another variation of the fourth embodiment of the invention; and

FIG. 15 is an oxygen concentration profile through the thickness of the dielectric layer of an EL device with a seed crystal layer and an EL device without a seed crystal layer during production of the dielectric layer.

### DESCRIPTION OF THE PREFERRED EMBODIMENTS

Preferred embodiments of the present invention are described below with reference to the accompanying figures. Note that effectively identical parts are denoted by the same reference numerals.

### Embodiment 1

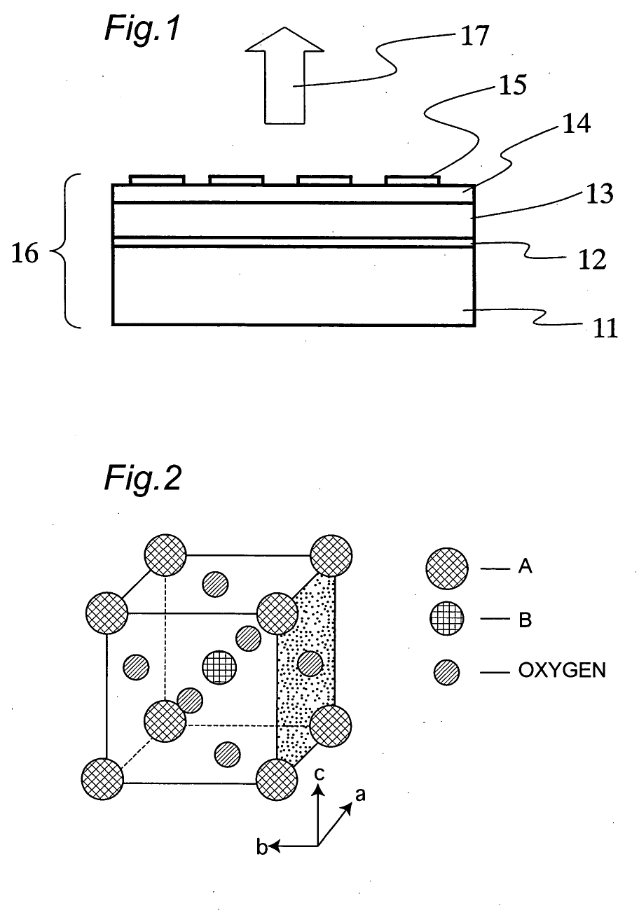

FIG. 1 is a section view of an EL device according to a first embodiment of the present invention. Sequentially layered on a base substrate 11, this EL device 16 has back electrodes 12 that are the first electrodes in a striped pattern, a dielectric layer 13 formed by thin film deposition of a dielectric material, an phosphor layer 14 made from an inorganic phosphor, and transparent front electrodes 15 that are the second electrodes in a striped pattern. The back electrodes 12 and front electrodes 15 are striped in mutually perpendicular directions. When a voltage is applied between the back electrodes 12 and front electrodes 15, light 17 emitted from the back electrodes 12 at the intersecting portion of the selected back electrodes 12 and the selected front electrodes 15 is emitted passing through the front electrodes 15.

The components of this EL device 16 are further described below.

The substrate 11 could be a ceramic substrate, a plastic substrate subjected to heat resistance processing to achieve high temperature heat resistance, a glass substrate, or any other substrate commonly used in EL devices. Nonalkaline glass in particular is desirable because of its high mechanical strength and low materials cost.

The back electrodes 12 are made of a conductor such as Pt, Pd, Au, Ir, Rh, or Ni. A layered construction of these conductors, or a combination of these conductors, could also be used. A transparent electrode material could also be used according to the application.

The front electrodes 15 are made from any optically transparent conductive material such as ITO (In₂O₃ doped with SnO₂), InZnO, or tin oxide. If light is to be emitted from the substrate 11 side, the materials of the back electrodes 12 and front electrodes 15 described here can be reversed.

The dielectric material used for the dielectric layer 13 can be any crystalline dielectric material with a perovskite structure having the general formulation ABO₃. In particular, barium titanate (BaTiO₃), barium strontium titanate ((Ba, Sr)TiO₃), bismuth titanate (BiTiO₃, Bi₄Ti₃O₁₂, where Bi:Ti=4:3), strontium titanate (SrTiO₃), and bismuth lanthanum titanate ((Bi, La)TiO₃, where Bi:La:Ti=3.35:0.75:3) feature excellent dielectric characteristics, insulation breakdown voltage characteristic, and film deposition characteristics. In addition, any of these dielectrics doped with 2 to 20 atomic percent C, Mg, Bi, or Zr is further preferable because the change in luminance due to changes in environmental temperature is small.

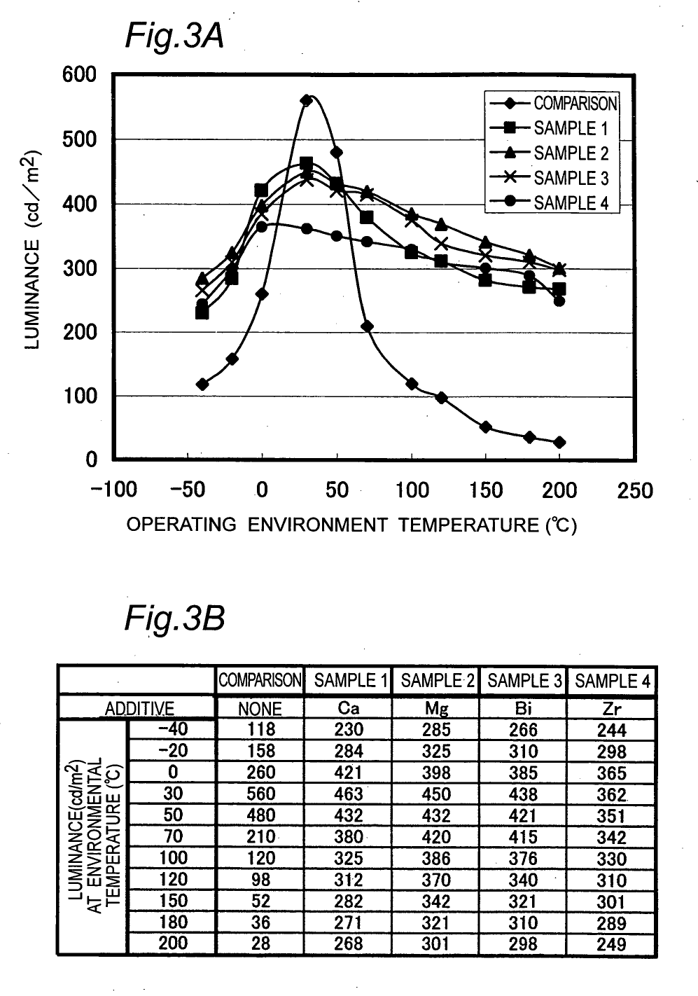

FIG. 3A shows the relationship between luminance and the environmental temperature for EL devices using BaTiO₃ doped with approximately 5 atomic percent Ca, Mg, Bi, and Zr. FIG. 3B shows the measurement data plotted in the graph in FIG. 3A. As will be known from FIG. 3A, all of the EL devices using a doped dielectric exhibited less change in luminance relative to change in environmental temperature than did the EL device using undoped BaTiO₃.

The dielectric layer 13 is preferably formed with a thin film deposition method such as sputtering, CVD, or MOCVD for the following reasons.

(a) These methods afford increased density in the dielectric layer 13, and the insulation breakdown voltage and dielectric characteristics are thus improved.

(b) A low cost glass substrate with low heat resistance can be used because the deposition temperature is low, that is, 600° C. or less.

(c) The surface roughness of the resulting dielectric layer 13 is low and the surface is smooth, eliminating the need for a separate smoothing process for the dielectric layer 13.

Through extensive experimentation, we discovered that the dielectric characteristics and insulation breakdown voltage characteristic of the dielectric layer 13 have a strong correlation to the microcrystalline structure and crystal orientation of the dielectric material forming the dielectric layer. The preferred crystalline structure and crystal orientation of the dielectric layer 13 according to the present invention are therefore further described above.

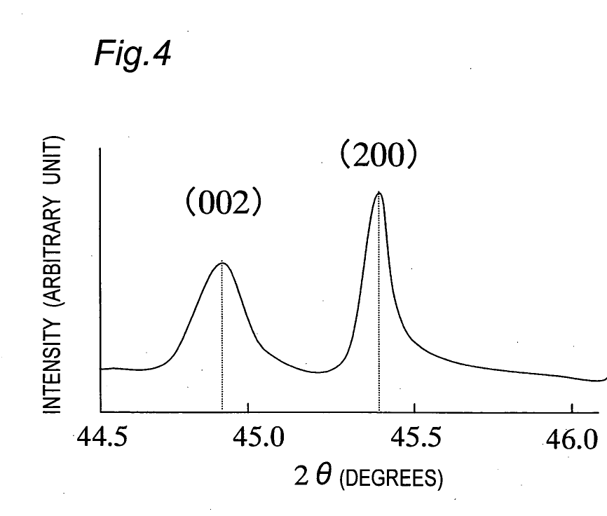

X-ray diffraction was used to analyze the crystalline structure and crystal orientation. FIG. 4 is an example of the diffraction pattern acquired by x-ray diffraction measurements. The diffraction pattern peaks appear according to the interplanar spacing of the lattice planes in the dielectric crystal. The a-axis and c-axis lattice constants were determined from the diffraction pattern, the ratio c/a of the c-axis lattice constant and the a-axis lattice constant (referred as simply c/a below) was used to evaluate the crystal structure, and the correlation between luminance and the c/a of BaTiO₃, (Ba, Sr)TiO₃, BiTiO₃, Bi₄Ti₃O₁₂, SrTiO₃, and (Bi, La)TiO₃ was studied. As a result, we discovered that a crystalline structure of the dielectric layer in which the lattice constant of the c-axis is greater than the lattice constant of the a-axis is preferable.

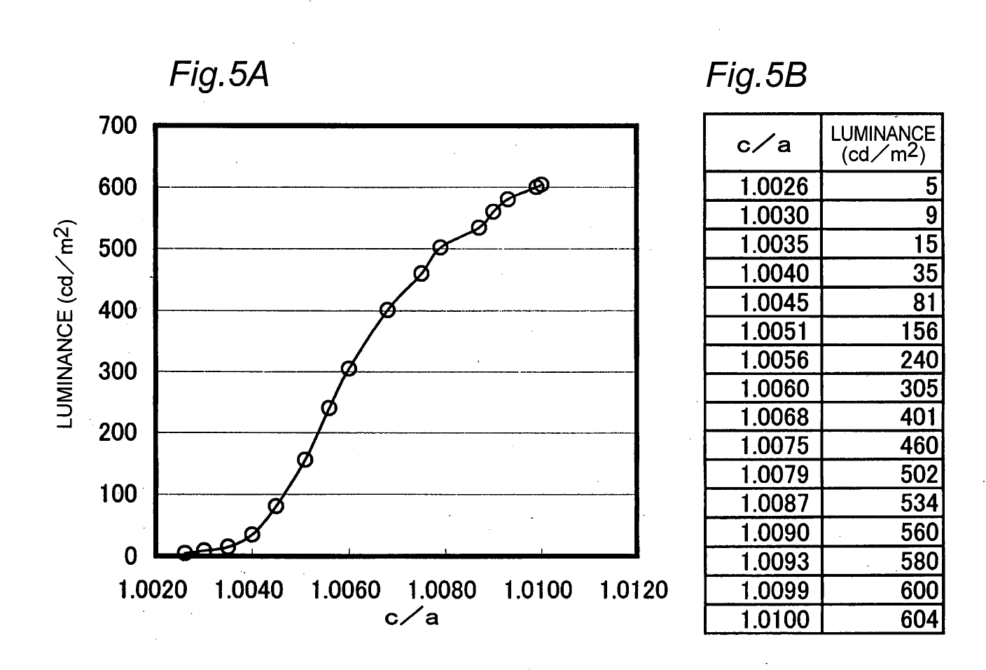

FIGS. 5A and 5B show the correlation between luminance and the c/a of the lattice constants of (Ba, Sr)TiO₃ crystal. As shown in FIGS. 5A and 5B, the device emits when the lattice constant ratio c/a is greater than 1, the emitted luminance increases sharply at a c/a of 1.004, and luminance of 300 cd/m² or greater is achieved at a c/a ratio of 1.006 or more. Similar results were obtained from the other dielectrics investigated.

In general, luminance of 150 cd/m² or greater is desirable for backlighting in cell phones, 300 cd/m² or greater is desirable for personal computer display applications, and 500 cd/m² or greater is needed for use in television displays.

Therefore, to start and maintain a constant luminance level, the lattice constant ratio c/a of the crystalline structure of the dielectric layer 13 must be 1.004 or greater.

Furthermore, a lattice constant ratio c/a of 1.005 or greater is desirable to achieve luminance of 150 cd/m² or greater, and a lattice constant ratio c/a of 1.006 or greater is desirable to achieve luminance of 300 cd/m² or greater.

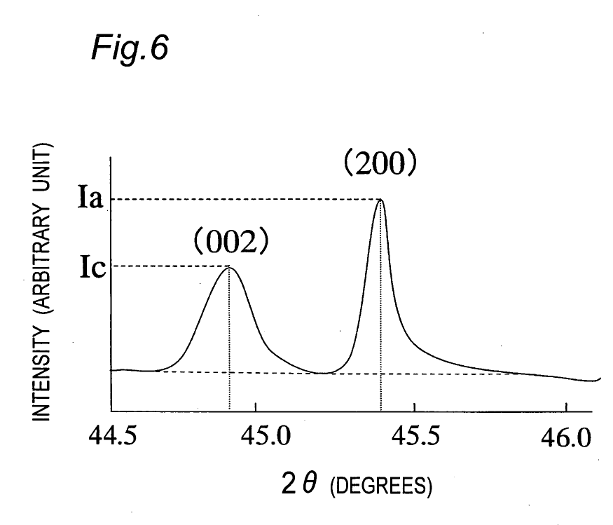

Referring next to FIG. 6, we investigated the correlation between luminance and the intensity ratio Ic/Ia where Ic/Ia was used to evaluate the crystal orientation and is the ratio between the x-ray diffraction intensity Ia from the (200) plane (the plane perpendicular to the a-axis), and the x-ray diffraction intensity Ic from the (002) plane (the plane perpendicular to the c-axis). As a result, we discovered that orienting the c-axis perpendicularly to the dielectric layer surface that is substantially parallel to the substrate surface yields a higher dielectric constant, and is therefore preferable.

For example, the correlation between luminance and the diffraction intensity ratio Ic/Ia of (Ba, Sr)TiO₃ is shown in FIG. 6. Note that here the chemical formula (Ba, Sr)TiO₃ means a solid solution of BaTiO₃ and SrTiO₃, and more specifically denotes (Ba₁₋ₓSrₓ)TiO₃.

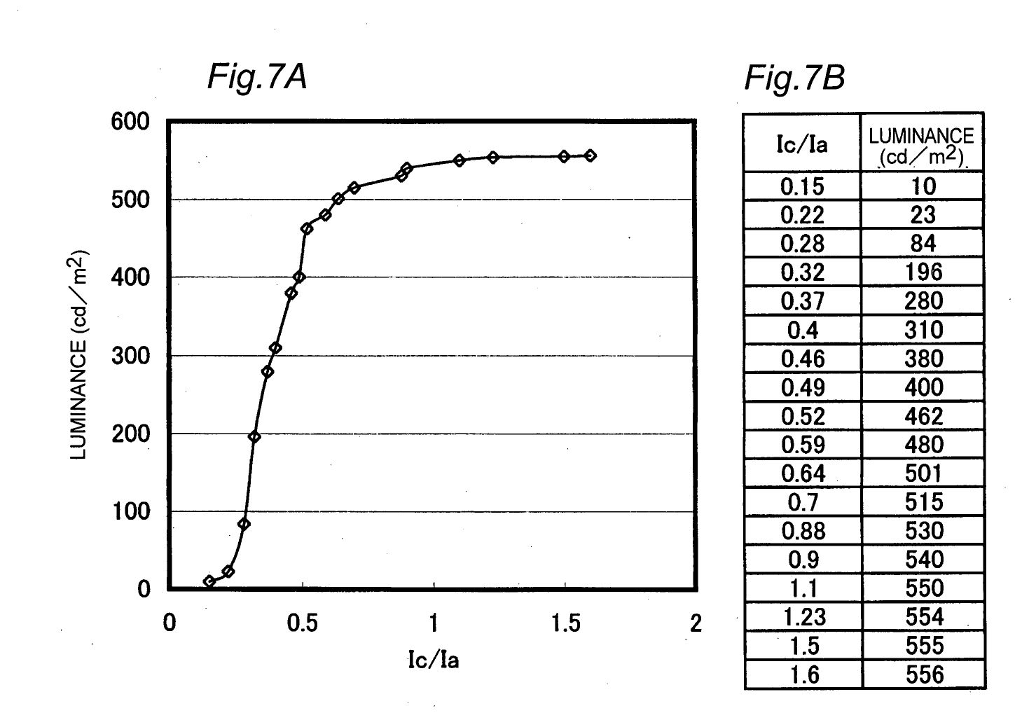

From FIGS. 7A and 7B we know that luminance increases sharply at an x-ray diffraction intensity ratio Ic/Ia of 0.4. Similar results were observed from the other dielectric materials. The crystal orientation of the dielectric material in the dielectric layer 13 is therefore preferably oriented so that the c-axis is perpendicular to the dielectric layer surface that is substantially parallel to the substrate, and the x-ray diffraction intensity ratio Ic/Ia is preferably 0.4 or greater.

It should be noted that in the case of powder x-ray diffraction data of bulk BaTiO₃, which is typical of a perovskite dielectric, the x-ray diffraction intensity Ic from the (002) plane of the crystal is 12.0, and the x-ray diffraction intensity Ia from the (200) plane is 37.0, and the intensity ratio Ic/Ia=0.32. Furthermore, with Ba_{0.77}Sr_{0.23}TiO₃, Ic/Ia=0.07. Bulk Ba_{0.5}Sr_{0.5}TiO₃ is cubic, c=a, and Ic/Ia=1 because the x-ray diffraction peaks of the two planes overlap.

The lattice constant ratio c/a and x-ray diffraction intensity ratio Ic/Ia of the crystals described above were measured with a Rigaku Denki diffractometer. Measurements were made using a Cu-Kα x-ray with x-ray output set at 60 kV, 40 mA; x-ray scanning speed of 0.2°/minute; 1° scattering slit and parallel slit for detection; and 0.30 mm wide receptor slit. The diffraction intensity equal to the difference of the peak diffraction intensity minus the baseline was calculated to determine the x-ray diffraction intensity ratio.

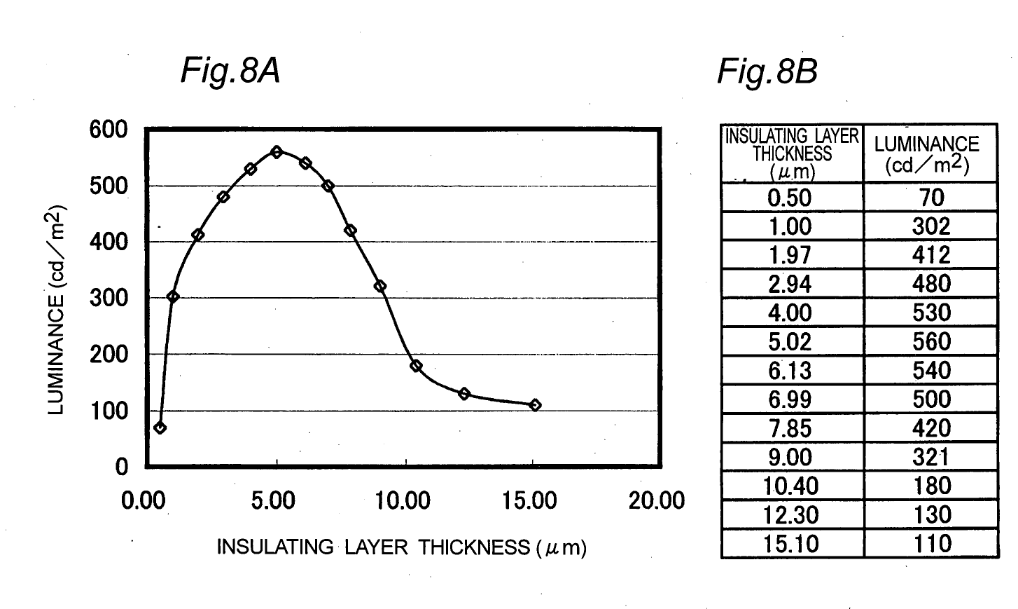

We also investigated the correlation between luminance and the layer thickness of the dielectric layer 13. The results are shown in FIGS. 8A and 8B. As will be known from FIGS. 8A and 8B, there is a sharp rise in luminance when the dielectric layer 13 thickness is 1 μm or more, and a subsequent drop in luminance when the layer thickness reaches 9 μm. This is because at thinner than 1 μm, the insulation breakdown voltage is low, sufficient drive voltage therefore cannot be applied to the dielectric layer 13, and the emitted luminance drops. Conversely, if layer thickness exceeds 9 μm, the voltage applied to the phosphor layer 14 drops, and the emission luminance thus drops. Therefore, the thickness of the dielectric layer 13 is preferably in the range from 1 μm to 9 μm where high luminance of 300 cd/m² or greater can be achieved.

The relationship between emitted luminance and the thickness of dielectric layers 13 in samples No. 1 to 19 is shown in Table 1.

TABLE 1

| | | | Phosphor | | X-ray | | |
|---|---|---|---|---|---|---|---|
| Sam- | Dielectric layer | | layer | | diffraction | | Lumin- |
| ple | | Thick | Compo- | Thick | characteristics | | ance |
| No. | Composition | (μm) | sition | (μm) | c/a | lc/la | (cd/m²) |
| 1 | (Ba,Sr)TiO₃ | 1 | SrS:Ce | 1 | 1 | 1 | 0 |
| 2 | (Ba,Sr)TiO₃ | 1 | SrS:Ce | 0.5 | 1.001 | 0.4 | 20 |
| 3 | (Ba,Sr)TiO₃ | 1 | SrS:Ce | 1 | 1.004 | 0.4 | 301 |
| 4 | (Ba,Sr)TiO₃ | 3 | SrS:Ce | 0.5 | 1.009 | 1.1 | 485 |
| 5 | (Ba,Sr)TiO₃ | 3 | SrS:Ce | 1 | 1.008 | 1.2 | 530 |
| 6 | (Ba,Sr)TiO₃ | 5 | SrS:Ce | 0.5 | 1.008 | 1.5 | 485 |
| 7 | (Ba,Sr)TiO₃ | 5 | SrS:Ce | 1 | 1.006 | 1.55 | 561 |
| 8 | (Ba,Sr)TiO₃ | 9 | SrS:Ce | 0.5 | 1.01 | 1.6 | 580 |
| 9 | (Ba,Sr)TiO₃ | 9 | SrS:Ce | 1 | 1.009 | 1.56 | 590 |
| 10 | (Ba,Sr)TiO₃ | 3 | ZnS:Mn | 0.5 | 1.007 | 1.52 | 465 |
| 11 | (Ba,Sr)TiO₃ | 3 | ZnS:Mn | 1 | 1.002 | 0.33 | 50 |
| 12 | (Ba,Sr)TiO₃ | 3 | ZnS:Mn | 0.5 | 1.002 | 0.3 | 46 |
| 13 | (Ba,Sr)TiO₃ | 3 | ZnS:Mn | 1 | 1.001 | 0.28 | 12 |
| 14 | (Ba,Sr)TiO₃ | 3 | ZnS:Mn | 0.5 | 1.004 | 0.4 | 165 |
| 15 | SrTiO₃ | 3 | SrS:Ce | 1 | 1.008 | 1.41 | 466 |
| 16 | SrTiO₃ | 3 | SrS:Ce | 0.5 | 1.007 | 1.5 | 436 |
| 17 | SrTiO₃ | 3 | SrS:Ce | 1 | 1.006 | 1.4 | 421 |
| 18 | SrTiO₃ | 3 | ZnS:Mn | 0.5 | 1.006 | 1.38 | 426 |
| 19 | SrTiO₃ | 3 | ZnS:Mn | 1 | 1.009 | 1.58 | 558 |

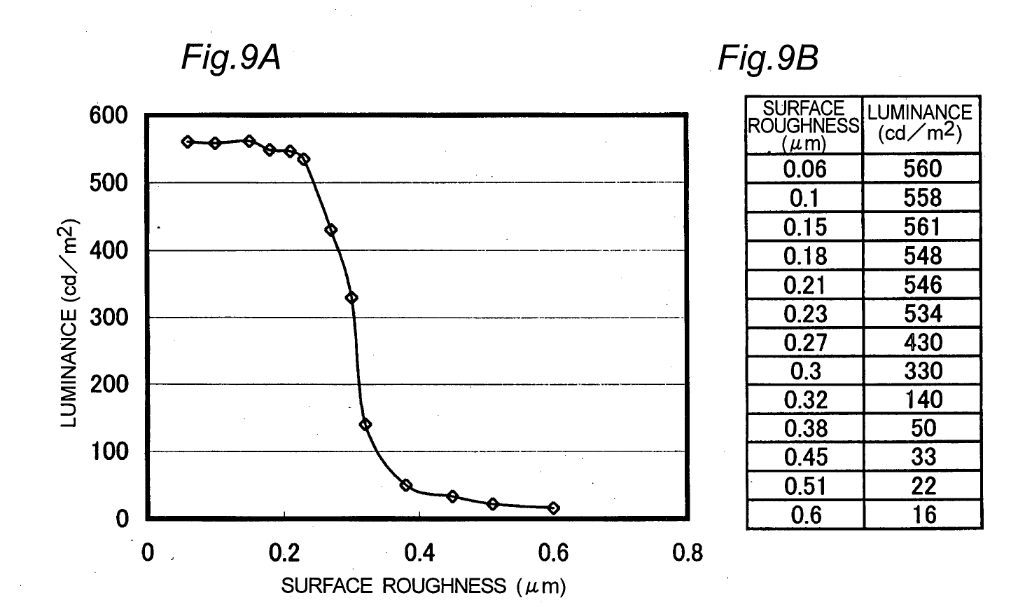

FIGS. 9A and 9B show the results of tests comparing luminance with the average surface roughness (“surface roughness” below) of the dielectric layer 13 adjacent to the phosphor layer 14. As will be known from FIGS. 9A and 9B, luminance increases when the surface roughness is 0.4 μm or less, surface roughness of 0.3 μm affords luminance of 300 cd/m², and surface roughness of 0.2 μm affords luminance of 500 cd/m². Luminance remains substantially constant when surface roughness is less than 0.2 μm. Furthermore, substantially no light is emitted when the surface roughness is 0.4 μm or greater. This is because if the surface roughness of the dielectric layer 13 is great, the insulation breakdown voltage of the phosphor layer 14 is low and a high voltage cannot be applied because the phosphor layer 14 will fail. The surface roughness must therefore be 0.3 μm or less to achieve luminance of 300 cd/m² or more. In addition, surface roughness must be 0.2 μm or less to achieve luminance of 500 cd/m² or more.

The surface roughness of the dielectric layer was measured using a stylus-type surface profiler (e.g., Dektak, ULVAC Corp.) Layer thickness less than 0.1 μm, such as the seed crystal layer and buffer layer, was measured by cross-section observation by TEM or SEM. A stylus-type surface profiler was also used to measure layer thickness of EL device layers from 0.1 μm to 0.5 μm thick.

We also discovered that by making the near-surface portion of the dielectric layer 13 amorphous, variations in surface roughness can be reduced and a significant improvement in reliability is achieved. Methods for making the surface portion of the dielectric layer 13 amorphous include reverse sputtering after the dielectric layer 13 is deposited, and applying a high frequency bias to the substrate 11 in the last stages of film deposition. Whether the surface portion is amorphous can be confirmed by, for example, emitting an electron beam to just the surface portion of the section perpendicular to the depth (thickness) direction of the surface using an analytical electron microscope. Those areas where any spot can not be observed but a halo can be observed are deemed to be amorphous phase.

A method of manufacturing this dielectric layer 13 using a sputtering technique is described next.

A high frequency bias is applied to the substrate 11 during the initial film deposition stage, seed crystals, that is, crystal nuclei, of the dielectric crystals are planted in the substrate 11, the high frequency bias is then cut and the dielectric is deposited to the desired thickness. By thus depositing the film after forming seed crystals, the dielectric crystals grow more easily and a high density dielectric layer 13 with good surface roughness of 0.3 μm or less can be formed. Note that repeatedly forming seed crystals while depositing the film rather than only at the start of the process produces a layer with more uniform density. This technique is particularly effective when depositing a thick dielectric layer.

Table 2 shows the results of a study of the correlation between emitted luminance and the film thickness of the seed crystal layer. As will be known from Table 2, each of the samples in which seed crystals were formed exhibits higher luminance than the samples in which seed crystals were not formed. This is because seed crystal formation increases the density of the dielectric layer 13 and thus yields a higher insulation breakdown voltage. A seed crystal layer thinner than 1 nm is undesirable because forming seed crystals has little effect and luminance drops. Conversely, a seed crystal layer thicker than 100 nm is also undesirable because internal stress increases in the film, and the dielectric layer 13 tends to separate from the substrate 11. The thickness of the seed crystal layer is therefore preferably in the range of 1 nm to 100 nm.

TABLE 2

| | Dielectric layer | | | | | | |
|---|---|---|---|---|---|---|---|
| | deposition conditions | | | | | | |
| | | | Seed | | | | |
| | Sub- | | Crystal | | | | |
| | strate | | Forma- | | | | |
| Sam- | temper- | Bias | tion | Dielectric layer | | | |
| ple | ature | power | time | Compo- | Thick | Phosphor | Lum. |
| No. | (° C.)) | (W) | (sec) | sition | (μm) | layer | (cd/m²) |
| 20 | 600 | 200 | 60 | BaTiO₃ | 3 | SrS:Ce | 450 |
| 21 | 500 | 300 | 80 | BaTiO₃ | 3 | SrS:Ce | 450 |
| 22 | 400 | 300 | 80 | BaTiO₃ | 3 | SrS:Ce | 450 |
| 23 | 500 | 300 | 100 | (Ba,Sr) | 3 | SrS:Ce | 450 |
| | | | | TiO₃ | | | |
| 24 | 400 | 300 | 80 | (Ba,Sr) | 3 | SrS:Ce | 450 |
| | | | | TiO₃ | | | |
| 25 | 400 | 300 | 80 | (Ba,Sr) | 1 | SrS:Ce | 450 |
| | | | | TiO₃ | | | |
| 26 | 400 | 300 | 80 | (Ba,Sr) | 9 | SrS:Ce | 450 |
| | | | | TiO₃ | | | |
| 27 | 600 | — | — | BaTiO₃ | 3 | SrS:Ce | 120 |
| 28 | 500 | — | — | BaTiO₃ | 3 | SrS:Ce | 30 |
| 29 | 400 | — | — | BaTiO₃ | 3 | SrS:Ce | 10 |
| 30 | 500 | — | — | (Ba,Sr) | 3 | SrS:Ce | 70 |
| | | | | TiO₃ | | | |
| 31 | 400 | — | — | (Ba,Sr) | 3 | SrS:Ce | 15 |
| | | | | TiO₃ | | | |

If the dielectric layer 13 is formed by CVD or MOCVD, the following source materials are used to deposit BaTiO₃, (Ba, Sr)TiO₃, BiTiO₃, Bi₄Ti₃O₁₂, SrTiO₃, or (Bi, La)TiO₃. Sputtering is used for seed crystal formation.

Dielectric layer materials include the following: alcoholates such as Ti(OiC₃H₇)₄, Ba(OCH₃)₂, Ta(OiC₂H₅)₅, Sr(OCH₃)₂, La(OiC₃H₇)₃, Zr(OiC₃H₇)₄; or Ba(METHD)₂, Ba(THD)₂, Sr(METHD)₂, Sr(THD)₂, Ti(MPD)(THD)₂, Ti(MPD)(METHD)₂, Ti(THD)₂(OiPr)₂, BiPh₃, Bi(MMP)₃, Bi(Ot-Am)₃, La(EDMDD)₃, Pb(METHD)₂, Pb(THD)₂, Zr(METHD)₄, Zr(THD)₂, Zr(MTHD)₄, Zr(Ot-Bu)₄, Zr(MMP)₄, or (Zr,Ti,Ba,Sr) 2-ethylhexoate.

Note that in the foregoing the following abbreviations are used.
METHD: 1-(2-) 2,2,6,6-tetramethyl-3,5-heptandionate
MTHD: 1-(methoxy)-2,2,6,6-tetramethyl-3,5-heptandionate
THD: 2,2,6,6 tetramethyl-3,5-heptanedionate
MPD: 2-methyl-2,4-pentanedioxide
MMP: 1-methoxy-2-methyl-2-propoxide
EDMDD: 6-ethyl-2,2-dimethyl-3,5-decadionate
OD: octane-2,4-dionate
ND: nonane-2-4-dionate
Ti(THD)₂(OiPr)₂: Ti(THD)₂(OiC₃H₇)₂
BiPh₃: triphenylbismuth
Bi(Ot-Am)₃: Bi(OtC₅H₁₁)₃
Zr(Ot-Bu)₄: Zr(OtC₄H₉)₄

A dielectric layer 13 such as described above in the EL device is desirable because this dielectric layer 13 enables applying a high voltage to the phosphor layer 14, and thus affords high luminance. In addition, the phosphor layer 14 can be formed directly on the dielectric layer 13. A smoothing process such as polishing the dielectric layer 13 is therefore unnecessary, and the manufacturing cost can be reduced.

FIG. 15 shows the oxygen concentration profile through the thickness direction of the dielectric layer 13 in the present invention. The concentration of oxygen in the film from the film surface to the substrate is shown using a (Ba,Sr)TiO₃ dielectric layer. Auger spectroscopy was used to determine the oxygen level, but the invention shall not be so limited. The oxygen concentration could be measured while etching from the film surface, for example. As will be known from FIG. 15, the dielectric layer of the present invention has more oxygen concentration at the substrate interface than does the comparison. This is attributed to the implantation of seed crystals, resulting in more oxygen concentration being absorbed. The dielectric layer of the comparison used here was formed under the same conditions except that seed crystals were not formed. There was also more oxygen concentration throughout the dielectric layer of the present invention than in the comparison.

Therefore, if In is the oxygen concentration at the substrate interface where seed crystals were formed according to the present invention, and lo is the oxygen concentration at the substrate interface without seed crystal formation, a high luminance, high voltage resistance film can be formed by assuring that In/Io>=1.1.

Furthermore, if Ibn is the oxygen concentration in the film when seed crystals are formed according to the present invention, and Ibo is the oxygen concentration in the film when seed crystals are not formed, a high luminance, high voltage resistance film can be formed by assuring that Ibn/Ibo>=1.05.

Therefore, this oxygen concentration also affects the crystal characteristics, could be a factor affording high luminance and a high insulation breakdown voltage.

Any generally commonly known phosphor can be used in the present invention, including sulfides such as ZnS:Mn, Cu, SrS, BaAl₂S₄, and CaS, or oxides such as ZnO, Y₂O₃, and ZnSiO₄, with a luminescent center such as Mn, Cr, or other transition metal, or Eu, Ce, or other rare earth metal added. Examples of specific phosphors are shown below.

Blue phosphors may include SrS:Cu, SrS:Cu,Ag, ZnS:Tm, BaAlS₄:Eu, and CaGa₂S₄:Ce. Blue-green phosphors may include ZnS:Cu and SrS:Ce. Green phosphors may include ZnS:Tb, F, ZnS:Tb, and ZnS:TbOF. Red phosphors may include CaS:Eu, CaSSe:Eu, and ZnS:Mn. White phosphors may include a set of at least one of the blue phosphors described above, at least one of the green phosphors described above, and at least one of the red phosphors described above.

### Embodiment 2

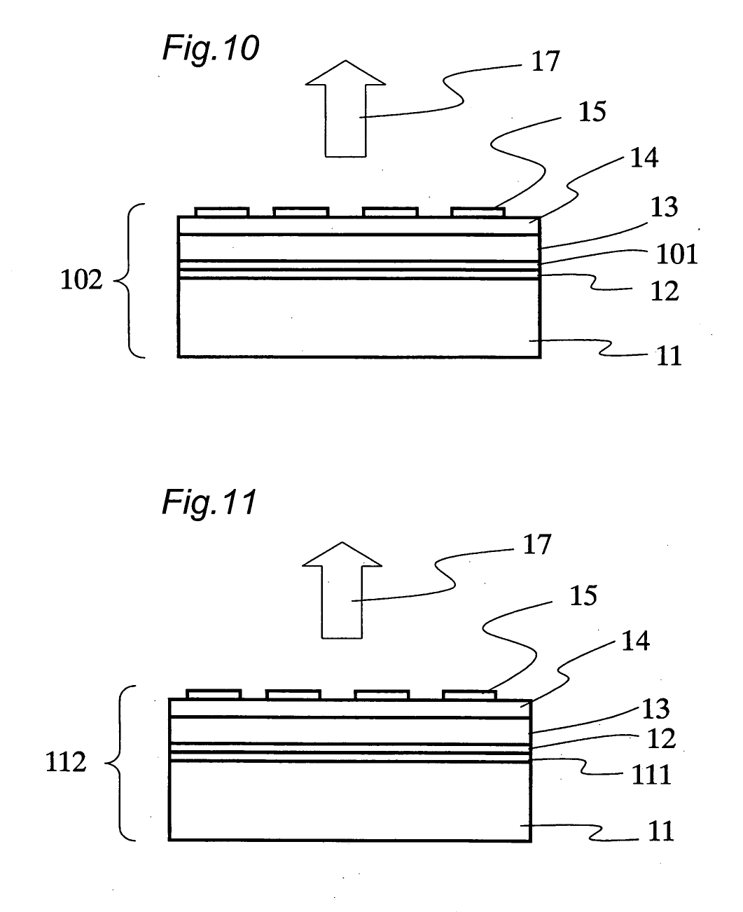

FIG. 10 is a section view of an EL device 102 according to a second embodiment of the present invention. This EL device 102 differs from the EL device in the first embodiment only in having a buffer layer 101 rendered between the back electrodes 12 and dielectric layer 13. Note that like parts here and in FIG. 1 are identified by like reference numerals.

The composition of the buffer layer 101 is described by the chemical formula MgₓSi₁₋ₓO (where 0.9<=x<=1). Forming the dielectric layer 13 over a buffer layer 101 of this composition affords good crystal characteristics and crystal orientation characteristics in the dielectric. Compositions outside the ranges of this chemical formula disturb the crystal structure of the NaCl structure or the face-centered cubic structure (fcc structure) that is the basic structure of MgO, thus degrade the crystal orientation, and are therefore undesirable.

Table 3 shows the results of tests exploring the relationship between the film thickness of the buffer layer 101 and luminance for samples 32 to 51. The buffer layer 101 thickness is preferably in the range 1 nm to 100 nm. If the buffer layer 101 is less than 1 nm thick, the buffer layer 101 does little to promote crystal growth, and luminance is therefore low. Furthermore, if the buffer layer 101 is more than 100 nm thick, luminance drops. Therefore, high luminance of 300 cd/m² or better can be achieved when the buffer layer 101 is 1 nm to 100 nm thick. The buffer layer 101 can be formed by sputtering or other suitable deposition method.

TABLE 3

| | | MgₓSi₁₋ₓO | | | Lattice | Lumin- |
|---|---|---|---|---|---|---|
| Sample | Dielectric | | Thick | Phosphor | constant | ance |
| No. | layer | x | (nm) | layer | ratio c/a | (cd/m²) |
| 32 | (Ba, Sr)TiO₃ | 0.98 | 5 | SrS:Ce | 1.009 | 560 |
| 33 | (Ba, Sr)TiO₃ | 0.95 | 5 | SrS:Ce | 1.008 | 510 |
| 34 | (Ba, Sr)TiO₃ | 0.92 | 5 | SrS:Ce | 1.008 | 440 |
| 35 | (Ba, Sr)TiO₃ | 0.90 | 5 | SrS:Ce | 1.007 | 453 |
| 36 | (Ba, Sr)TiO₃ | 0.98 | 5 | SrS:Ce | 1.008 | 524 |
| 37 | (Ba, Sr)TiO₃ | 0.98 | 5 | SrS:Ce | 1.006 | 450 |
| 38 | (Ba, Sr)TiO₃ | 0.98 | 5 | SrS:Ce | 1.007 | 465 |
| 39 | (Ba, Sr)TiO₃ | 0.85 | 5 | SrS:Ce | 1.002 | 50 |
| 40 | (Ba, Sr)TiO₃ | 0.98 | 5 | SrS:Ce | 1.002 | 46 |
| 41 | (Ba, Sr)TiO₃ | 0.98 | 5 | SrS:Ce | 1.001 | 12 |
| 42 | (Ba, Sr)TiO₃ | 0.88 | 5 | SrS:Ce | 1.004 | 165 |
| 43 | Bi₄Ti₃O₁₂ | 0.98 | 5 | SrS:Ce | 1.008 | 466 |
| 44 | Bi₄Ti₃O₁₂ | 0.95 | 5 | SrS:Ce | 1.007 | 436 |
| 45 | Bi₄Ti₃O₁₂ | 0.92 | 5 | SrS:Ce | 1.006 | 421 |
| 46 | Bi₄Ti₃O₁₂ | 0.90 | 5 | SrS:Ce | 1.006 | 426 |
| 47 | Bi₄Ti₃O₁₂ | 0.99 | 5 | SrS:Ce | 1.009 | 558 |
| 48 | Bi₄Ti₃O₁₂ | 0.98 | 0.5 | SrS:Ce | 1.001 | 8 |
| 49 | Bi₄Ti₃O₁₂ | 0.98 | 0.8 | SrS:Ce | 1.002 | 20 |
| 50 | Bi₄Ti₃O₁₂ | 0.98 | 110 | SrS:Ce | 1.006 | 68 |
| 51 | Bi₄Ti₃O₁₂ | 0.98 | 130 | SrS:Ce | 1.007 | 44 |

### Embodiment 3

FIG. 11 is a section view of an EL device 112 according to a third embodiment of the present invention. Compared with the EL devices of the first and second embodiments, this EL device 112 is the same as the EL devices shown in FIG. 1 and FIG. 10 except that a bottom layer 111 is rendered between the substrate 11 and the back electrodes 12 made of a conductor containing one of Pt, Pd, Au, Ir, Rh, and Ni.

The bottom layer 111 is a 5 nm to 50 nm thick film of Ti, Co, or Ni. Rendering this bottom layer 111 improves adhesion between the substrate 11 and back electrodes 12.

### Embodiment 4

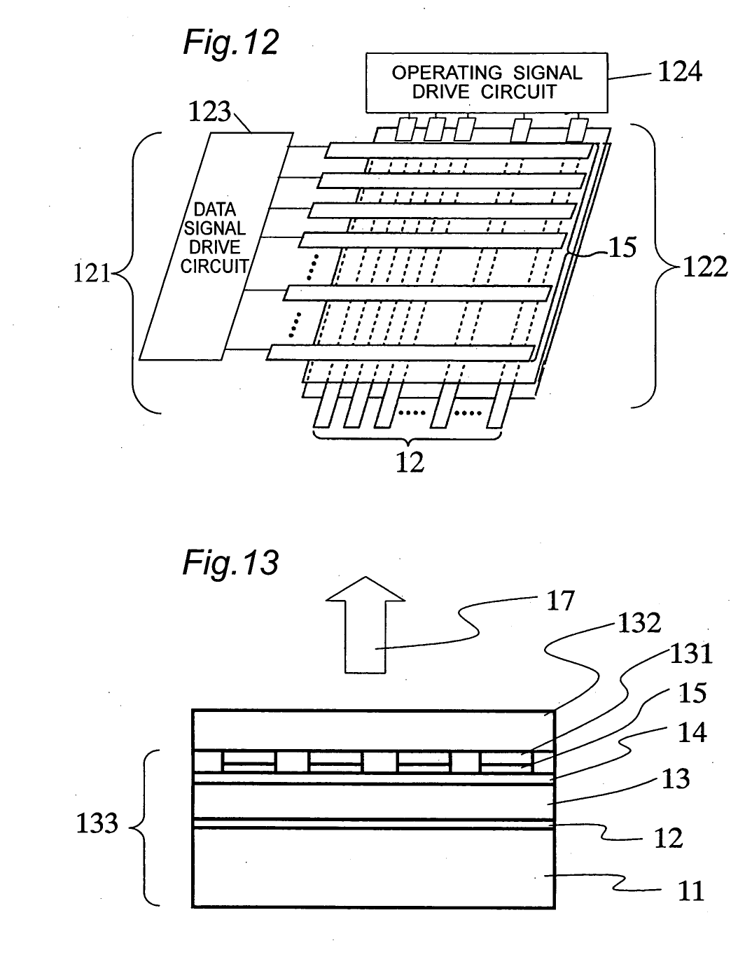

FIG. 12 schematically shows the main parts of a display device using an EL device according to a fourth embodiment of the present invention. This display device 121 is a passive matrix drive device having a plurality of EL devices 122 as described in any of the first to third embodiments above rendered in a two-dimensional matrix, a data signal drive circuit 123, and an operating signal drive circuit 124. The striped back electrodes 12 are connected to the operating signal drive circuit 124, and the front electrodes 15 striped perpendicularly to the back electrodes 12 are connected to the data signal drive circuit 123. A data signal voltage output from the data signal drive circuit 123, and an operating signal voltage output from the operating signal drive circuit 124, are applied to a particular back electrode 12 and front electrode 15 to cause the EL device 122 at the intersection of the of those electrodes to emit.

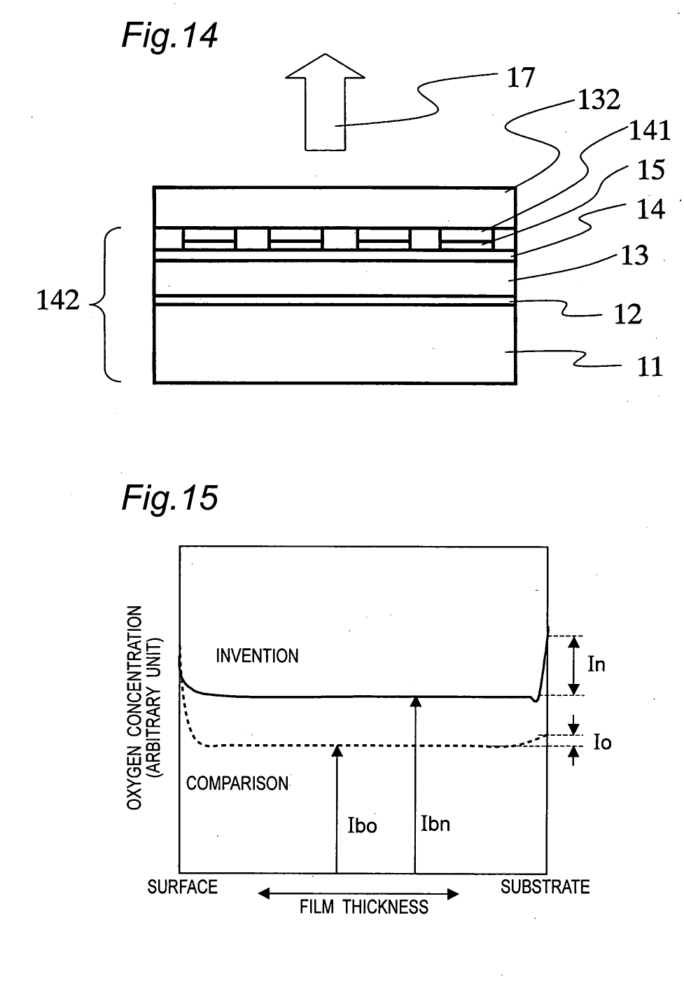

As shown in FIG. 13, a display device that can display colors ranging from green to red can be achieved by using an EL device having a color conversion layer 131 rendered on top of the front electrodes 15. In addition, a full-color display device can be provided by rendering a red, blue, green color filter 141 over the front electrodes 15 as shown in FIG. 14 if EL devices that emit white light are used.

A high luminance, low cost display device suitable for use in television monitors and other types of display devices can thus be provided by the present invention.

Some specific examples are described below.

### EXAMPLE 1

An EL device according to the first example of this invention is described below. This EL device 16 having the structure shown in FIG. 1 was manufactured by the following process.

(a) A commercially available nonalkaline glass substrate (“glass substrate” below) 0.635 mm thick and 2.54 cm*2.54 cm (1″ square) was used for the substrate 11.

(b) Ta and Pt layers were sputtered in the same sequence on the substrate 11 to form the back electrodes 12. The lower Ta layer was 30 nm thick, and the upper Pt layer was 200 nm thick.

(c) After forming seed crystals by sputtering for 100 seconds using a (Ba,Sr)TiO₃ dielectric as the sputter target while applying a high frequency bias to the substrate 11, the high frequency bias was stopped and sputtering was continued for another 60 minutes to deposit the dielectric layer.

(d) A high frequency bias was then again applied to the substrate 11 while sputtering for another 100 seconds to make the surface of the dielectric layer amorphous. A dielectric layer 13 was thus formed on the back electrodes 12.

The sputtering conditions when depositing the dielectric layer included using a mixed argon:oxygen gas at a flow ratio of 25:0.5 as the sputter gas at a sputter pressure of approximately 1.6 Pa (12 mTorr). Sputter power during seed crystal formation was 500 W, and 2 kW during film deposition. The high frequency bias was 300 W, and the substrate temperature was 500° C.

As a result, the seed crystal layer thickness was approximately 10 nm, and a dielectric layer 13 with a dielectric constant of 510, breakdown voltage of 3×10⁶ V/cm, and average surface roughness of 0.08 μm was formed.

The lattice constant ratio c/a of the crystals in the dielectric layer was 1.007, and the x-ray diffraction intensity ratio Ic/Ia between the (002) and (200) planes of the crystal structure was 0.7.

(e) An approximately 500 nm thick phosphor layer 14 was then formed by sputtering a SrS:Ce (where Ce is approximately 1.5 mol %) phosphor as the sputter target on the dielectric layer 13 using a high frequency magnetron sputtering technique. The sputter gas was argon at a 0.53 Pa (4 mTorr) sputter pressure; the glass substrate temperature was 300° C.

(f) An ITO film was then sputtered on the phosphor layer 14 to form the front electrodes 15 from an ITO film and complete the EL device 16.

When a 200-V, 1-kHz AC voltage with a 50 μsec pulse width was applied to the resulting EL device 16, the measured luminance was 500 cd/m². Dielectric breakdown was not observed even when 300 V was applied.

### EXAMPLE 2

An EL device as shown in FIG. 10 was manufactured by the foregoing method except for the buffer layer 101.

The buffer layer 101 was formed by sputtering a target of the composition Mg_{0.98}Si_{0.02}O over the back electrodes 12.

When a 200-V, 1-kHz AC voltage with a 50 μsec pulse width was applied to the resulting EL device 16, the measured luminance was 524 cd/m².

An EL device according to the present invention can be manufactured at low cost while providing high luminance, and is thus well suited as a surface emitting light source in display devices used in digital cameras, cell phones, PDAs, personal computers, televisions, and automobiles, for example, and as a backlight for liquid crystal displays.

Although the present invention has been described in connection with the preferred embodiments thereof with reference to the accompanying drawings, it is to be noted that various changes and modifications will be apparent to those skilled in the art. Such changes and modifications are to be understood as included within the scope of the present invention as defined by the appended claims, unless they depart therefrom.

1. A light-emitting device comprising:
an emitting layer including:
a phosphor layer; and
a dielectric layer composed of a crystalline material having a perovskite structure wherein a lattice constant of a c-axis is greater than a lattice constant of an a-axis; and
a pair of electrodes for applying an electric field to the phosphor layer.

2. The light-emitting device according to claim 1, wherein the lattice constant of the c-axis is at least 1.004 times the lattice constant of the a-axis.

3. The light-emitting device according to claim 1, wherein the lattice constant of the c-axis is at least 1.006 times the lattice constant of the a-axis.

4. The light-emitting device according to claim 1, wherein the c-axis is oriented substantially perpendicularly to a surface of the dielectric layer.

5. The light-emitting device according to claim 1, wherein in an x-ray diffraction intensity at the surface of the dielectric layer, a diffraction intensity from a plane perpendicular to the c-axis or a (002) plane of the crystalline material is at least 0.4 times a maximum diffraction intensity from a plane perpendicular to the a-axis or a (200) plane of the crystalline material, respectively.

6. The light-emitting device according to claim 1, wherein an average surface roughness of a surface of the dielectric layer adjacent to the phosphor layer is 0.3 μm or less.

7. The light-emitting device according to claim 1, wherein a surface portion of the dielectric layer adjacent to the phosphor layer is amorphous.

8. The light-emitting device according to claim 1, wherein the dielectric layer is 1 μm to 9 μm thick.

9. The light-emitting device according to claim 1, further comprising rendered between an electrode of the pair of electrodes and the dielectric layer is a buffer layer containing an oxide of the composition MgₓSi₁₋ₓO (where 0.9<=x<=1).

10. The light-emitting device according to claim 9, wherein a thickness of the buffer layer is in a range of 1 nm to 100 nm.

11. The light-emitting device according to claim 1, wherein the dielectric layer contains at least one of a dielectric material selected from barium titanate, barium strontium titanate, bismuth titanate, strontium titanate, and bismuth lanthanum titanate.

12. The light-emitting device according to claim 11, wherein the dielectric is doped with at least one of the elements selected from Ca, Mg, Bi, and Zr.

13. The light-emitting device according to claim 1, wherein the emitting layer further includes a seed layer for forming the dielectric layer.

14. The light-emitting device according to claim 1, wherein the emitting layer further includes a plurality of seed layers each deposited during a formation of the dielectric layer.

15. The light-emitting device according to claim 1, further comprising:
a substrate and an adhesion layer, wherein
a back electrode of the pair of electrodes is formed over the substrate,
the emitting layer is formed over the back electrode, and
the adhesion layer is formed between the substrate and the back electrode.

16. The light-emitting device according to claim 15, wherein the adhesion layer is composed of Ti, Co, or Ni.

17. The light-emitting device according to claim 16, wherein the back electrode is made of a conductor containing any one of Pt, Pd, Au, Ir, Rh, Ni, and Ag.

18. The light-emitting device according to claim 1, further comprising a color conversion layer formed over a top electrode of the pair of electrodes, wherein the top electrode is formed over the emitting layer.

19. The light-emitting device according to claim 18, further comprising a color filter layer formed over the color conversion layer.

20. A light-emitting device according to claim 1, further comprising a glass substrate over which the emitting layer and pair of electrodes are formed.

21. A light-emitting device comprising:
an emitting layer including:
a phosphor layer; and
a dielectric layer composed of a crystalline material having a perovskite structure having a c-axis oriented substantially perpendicularly to a surface of the dielectric layer which is substantially parallel to a surface of a substrate over which the emitting layer is formed; and
a pair of electrodes for applying an electric field to the phosphor layer.

22. The light-emitting device according to claim 21, wherein a lattice constant of the c-axis is at least 1.004 times a lattice constant of an a-axis.

23. The light-emitting device according to claim 21, wherein a lattice constant of the c-axis is at least 1.006 times a lattice constant of an a-axis.

24. The light-emitting device according to claim 21, wherein a lattice constant of the c-axis is greater than a lattice constant of an a-axis of the crystalline material.

25. The light-emitting device according to claim 21, wherein in an x-ray diffraction intensity at the surface of the dielectric layer, a diffraction intensity from a plane perpendicular to the c-axis or a (002) plane of the crystalline material is at least 0.4 times a maximum diffraction intensity from a plane perpendicular to an a-axis or a (200) plane of the crystalline material, respectively.

26. The light-emitting device according to claim 21, wherein an average surface roughness of the surface of the dielectric layer adjacent to the phosphor layer is 0.3 μm or less.

27. The light-emitting device according to claim 21, wherein a surface portion of the dielectric layer adjacent to the phosphor layer is amorphous.

28. The light-emitting device according to claim 21, wherein the dielectric layer is 1 μm to 9 μm thick.

29. The light-emitting device according to claim 21, further comprising rendered between an electrode of the pair of electrodes and the dielectric layer a buffer layer containing an oxide of the composition MgₓSi₁₋ₓO (where 0.9<=x<=1).

30. The light-emitting device according to claim 29, wherein a thickness of the buffer layer is in a range of 1 nm to 100 nm.

31. The light-emitting device according to claim 21, wherein the dielectric layer contains at least one of a dielectric material selected from barium titanate, barium strontium titanate, bismuth titanate, strontium titanate, and bismuth lanthanum titanate.

32. The light-emitting device according to claim 31, wherein the dielectric is doped with at least one of the elements selected from Ca, Mg, Bi, and Zr.

33. The light-emitting device according to claim 21, wherein the emitting layer further includes a seed layer for forming the dielectric layer.

34. The light-emitting device according to claim 21, wherein the emitting layer further includes a plurality of seed layers each deposited during a formation of the dielectric layer.

35. The light-emitting device according to claim 21, further comprising:
an adhesion layer, wherein
a back electrode of the pair of electrodes is formed over the substrate,
the emitting layer is formed over the back electrode, and
the adhesion layer is formed between the substrate and the back electrode.

36. The light-emitting device according to claim 35, wherein the adhesion layer is composed of Ti, Co, or Ni.

37. The light-emitting device according to claim 36, wherein the back electrode is made of a conductor containing any one of Pt, Pd, Au, Ir, Rh, Ni, and Ag.

38. The light-emitting device according to claim 21, further comprising a color conversion layer formed over a top electrode of the pair of electrodes, wherein the top electrode is formed over the emitting layer.

39. The light-emitting device according to claim 38, further comprising a color filter layer formed over the color conversion layer.

40. A light-emitting device according to claim 21, wherein the substrate is a glass substrate over which the emitting layer and pair of electrodes are formed.

41. A light-emitting device comprising:
an emitting layer including:
a phosphor layer; and
a dielectric layer composed of a crystalline material having a perovskite structure wherein in an x-ray diffraction intensity at a surface of the dielectric layer, a diffraction intensity from a plane perpendicular to a c-axis or a (002) plane of the crystalline material is at least 0.4 times a maximum diffraction intensity from a plane perpendicular to an a-axis or a (200) plane of the crystalline material, respectively; and
a pair of electrodes for applying an electric field to the phosphor layer.

42. The light-emitting device according to claim 41, wherein a lattice constant of the c-axis is at least 1.004 times a lattice constant of the a-axis.

43. The light-emitting device according to claim 41, wherein a lattice constant of the c-axis is at least 1.006 times a lattice constant of the a-axis.

44. The light-emitting device according to claim 41, wherein the dielectric layer is primarily composed of a crystal having the c-axis is oriented substantially perpendicularly to a surface of the dielectric layer.

45. The light-emitting device according to claim 41, a lattice constant of the c-axis is greater than a lattice constant of the a-axis.

46. The light-emitting device according to claim 41, wherein an average surface roughness of the surface of the dielectric layer adjacent to the phosphor layer is 0.3 μm or less.

47. The light-emitting device according to claim 41, wherein a surface portion of the dielectric layer adjacent to the phosphor layer is amorphous.

48. The light-emitting device according to claim 41, wherein the dielectric layer is 1 μm to 9 μm thick.

49. The light-emitting device according to claim 41, further comprising rendered between an electrode of the pair of electrodes and the dielectric layer a buffer layer containing an oxide of the composition MgₓSi₁₋ₓO (where 0.9<=x<=1).

50. The light-emitting device according to claim 49, wherein a thickness of the buffer layer is in a range of 1 nm to 100 nm.

51. The light-emitting device according to claim 41, wherein the dielectric layer contains at least one of a dielectric material selected from barium titanate, barium strontium titanate, bismuth titanate, strontium titanate, and bismuth lanthanum titanate.

52. The light-emitting device according to claim 51, wherein the dielectric is doped with at least one of the elements selected from Ca, Mg, Bi, and Zr.

53. The light-emitting device according to claim 41, wherein the emitting layer further includes a seed layer for forming the dielectric layer.

54. The light-emitting device according to claim 41, wherein the emitting layer further includes a plurality of seed layers each deposited during a formation of the dielectric layer.

55. The light-emitting device according to claim 41, further comprising:
a substrate and an adhesion layer, wherein
a back electrode of the pair of electrodes is formed over the substrate,
the emitting layer is formed over the back electrode, and
the adhesion layer is formed between the substrate and the back electrode.

56. The light-emitting device according to claim 55, wherein the adhesion layer is composed of Ti, Co, or Ni.

57. The light-emitting device according to claim 56, wherein the back electrode is made of a conductor containing any one of Pt, Pd, Au, Ir, Rh, Ni, and Ag.

58. The light-emitting device according to claim 41, further comprising a color conversion layer formed over a top electrode of the pair of electrodes, wherein the top electrode is formed over the emitting layer.

59. The light-emitting device according to claim 58, further comprising a color filter layer formed over the color conversion layer.

60. A light-emitting device according to claim 41, further comprising a glass substrate over which the emitting layer and pair of electrodes are formed.

61. A light-emitting device comprising:
an emitting layer including:
a phosphor layer; and
a dielectric layer composed of a crystalline material having a perovskite structure wherein a surface portion of the dielectric layer adjacent to the phosphor layer is amorphous; and
a pair of electrodes for applying an electric field to the phosphor layer.

62. The light-emitting device according to claim 61, wherein a lattice constant of a c-axis of the perovskite structure is at least 1.004 times a lattice constant of an a-axis of the perovskite structure.

63. The light-emitting device according to claim 61, wherein a lattice constant of a c-axis of the perovskite structure is at least 1.006 times a lattice constant of an a-axis of the perovskite structure.

64. The light-emitting device according to claim 61, wherein a c-axis is oriented substantially perpendicularly to a surface of the dielectric layer.

65. The light-emitting device according to claim 61, wherein in an x-ray diffraction intensity at the surface of the dielectric layer, a diffraction intensity from a plane perpendicular to a c-axis or a (002) plane of the crystalline material is at least 0.4 times a maximum diffraction intensity from a plane perpendicular to an a-axis or a (200) plane of the crystalline material, respectively.

66. The light-emitting device according to claim 61, wherein an average surface roughness of a surface of the dielectric layer adjacent to the phosphor layer is 0.3 μm or less.

67. The light-emitting device according to claim 61, wherein a lattice constant of a c-axis is greater than a lattice constant of an a-axis of the perovskite structure.

68. The light-emitting device according to claim 61, wherein the dielectric layer is 1 μm to 9 μm thick.

69. The light-emitting device according to claim 61, further comprising rendered between the an electrode of the pair of electrodes and the dielectric layer is a buffer layer containing an oxide of the composition MgₓSi₁₋ₓO (where 0.9<=x<=1).

70. The light-emitting device according to claim 69, wherein a thickness of the buffer layer is in a range of 1 nm to 100 nm.

71. The light-emitting device according to claim 61, wherein the dielectric layer contains at least one of a dielectric material selected from barium titanate, barium strontium titanate, bismuth titanate, strontium titanate, and bismuth lanthanum titanate.

72. The light-emitting device according to claim 71, wherein the dielectric is doped with at least one of the elements Ca, Mg, Bi, and Zr.

73. The light-emitting device according to claim 61, wherein the emitting layer further includes a seed layer for forming the dielectric layer.

74. The light-emitting device according to claim 61, wherein the emitting layer further includes a plurality of seed layers each deposited during a formation of the dielectric layer.

75. The light-emitting device according to claim 61, further comprising:
a substrate and an adhesion layer, wherein
a back electrode of the pair of electrodes is formed over the substrate,
the emitting layer is formed over the back electrode, and
the adhesion layer is formed between the substrate and the back electrode.

76. The light-emitting device according to claim 75, wherein the adhesion layer is composed of Ti, Co, or Ni.

77. The light-emitting device according to claim 76, wherein the back electrode is made of a conductor containing any one of Pt, Pd, Au, Ir, Rh, Ni, and Ag.

78. The light-emitting device according to claim 61, further comprising a color conversion layer formed over a top electrode of the pair of electrodes, wherein the top electrode is formed over the emitting layer.

79. The light-emitting device according to claim 78, further comprising a color filter layer formed over the color conversion layer.

80. A light-emitting device according to claim 61, further comprising a glass substrate over which the emitting layer and pair of electrodes are formed.

81. A display device of a passive matrix drive type comprising:
a light-emitting device having a plurality of mutually parallel first electrodes, a dielectric layer, a phosphor layer, and a plurality of mutually parallel second electrodes which traverse the plurality of mutually parallel first electrodes; and
a drive circuit for applying a drive voltage between a first electrode of the plurality of mutually parallel first electrodes and a second electrode of the plurality of mutually parallel second electrodes for illuminating the phosphor layer,
wherein the dielectric layer is made from a dielectric composed of a crystalline material with a perovskite structure wherein a lattice constant of a c-axis is greater than a lattice constant of an a-axis.

82. The display device according to claim 81, wherein the lattice constant of the c-axis is at least 1.004 times the lattice constant of the a-axis.

83. The display device according to claim 81, wherein the lattice constant of the c-axis is at least 1.006 times the lattice constant of the a-axis.

84. The display device according to claim 81, wherein the dielectric layer is primarily composed of a crystal having the c-axis oriented substantially perpendicularly to a surface of the dielectric layer.

85. The display device according to claim 81, wherein in an x-ray diffraction intensity at the surface of the dielectric layer, a diffraction intensity from a plane perpendicular to the c-axis or a (002) plane of the crystalline material is at least 0.4 times a maximum diffraction intensity from a plane perpendicular to the a-axis or a (200) plane of the crystalline material, respectively.
